(19) United States
(12) Patent Application Publication
(10) Pub. No.: US 2026/0033672 A1
(43) Pub. Date: Feb. 5, 2026

(54) EASY-BOWL-REMOVAL/MOUNTING MIXER

(71) Applicant: Hsi-Hui YU, Taichung City (TW)

(72) Inventor: Hsi-Hui YU, Taichung City (TW)

(21) Appl. No.: 18/791,350

(22) Filed: Jul. 31, 2024

(51) Int. Cl. A47J 43/07; A47J 43/044

(52) U.S. Cl. CPC A47J 43/0727; A47J 43/044; A47J 2043/04463

(57) ABSTRACT

An easy-bowl-removal/mounting mixer includes: a base; a support frame including a frame body and two extension/retraction units, the frame body being connected to the base and having a frame channel and being formed, in a position adjacent to each of two ends, with an extension/retraction hole, the extension/retraction units being respectively connected to the extension/retraction holes and movable between an upward moved position to project outside of the top surface of the frame body and a downward moved position to not project outside of the top surface of the frame body; and a mixing bowl including a bowl body defining a mixing space and including a bowl peg on the outside surface for insertion into and removal from the frame channel, support portions being provided on the outside surface of the bowl body and forming bowl channels, into which the extension/retraction units are insertable for mounting the mixing bowl.

### BACKGROUND OF THE INVENTION

### (a) Technical Field of the Invention

The present invention relates generally to a mixer, and more particularly to a mixer of which a mixing blow is easily mountable and removable.

### (b) Description of the Prior Art

A known mixer 1 for stirring food is shown in FIG. 1, generally comprising a base 2, a support frame 3, and a mixing bowl 4. The support frame 3 is arranged on the base 2 and is drivable by a crank handle 5 of the base 2 to move for elevating and lowering. The support frame 3 includes a frame channel 6 extending in the horizontal direction and two frame bars 7 extending in the vertical direction. The mixing bowl 4 includes ae bowl peg 8 extending in the horizontal direction and two bowl channels 9 extending in the vertical direction.

To mount the mixing bowl 4 to the support frame 3, the crank handle 5 must be first operated to drive the support frame 3 to lower down, and then, the mixing bowl 4 is moved and placed at a slightly inclined angle to allow the bowl peg 8 to insert into the frame channel 6, and then, the frame bars 7 are align to the bowl channels 9 to insert therein in order to completely the operation of mounting the mixing bowl 4 on the support frame 3.

However, as the frame bars 7 of the support frame 3 are fixed in position, before the bowl peg 8 of the mixing bowl 4 is inserted into the frame channel 6 of the support frame 3, a force must be applied to lift the mixing bowl 4 to an inclined condition to avoid the frame bars 7. Further, as the bowl peg 8 is located at an opposite side of the eyesight of the operator and is blocked by the mixing bowl 4, the bowl peg 8 cannot be properly observed during the operation, and it becomes hard to align the bowl peg 8 with the frame channel 6. The operation of assembling is thus very troublesome and can only be carried out with two persons. Further, during the time period after the bowl peg 8 of the mixing bowl 4 has been inserted into the frame channel 6 of the support frame 3 and before the frame bars 7 are inserted into the bowl channels 9, the operator has to continuously hold the mixing bowl 4, and this makes the operation of assembling very effort consuming. Of course, not only the process of assembling the mixing bowl 4 is very tedious and effort consuming, an operation of removing the mixing bowl 4 from the support frame 3 is also similarly tedious and effort consuming.

### SUMMARY OF THE INVENTION

In view of this, the present invention is made to alleviate the problem of the prior art that the known food mixer is tedious and effort consuming for mounting and removing the mixing bowl.

An objective of the present invention is to provide an easy-bowl-removal/mounting mixer, which makes operations of mounting and removing a mixing bowl easy and effort saving.

For such an objective, the present invention provides an easy-bowl-removal/mounting mixer, which comprises: a base; a support frame, which comprises a frame body and two extension/retraction units, a middle portion of the frame body being connected, at an outer side thereof, to the base, the middle portion of the frame body being formed, in an inner side surface thereof, with a frame channel that extends in a horizontal direction, the frame body being formed, in a position adjacent to each of two ends thereof, with an extension/retraction hole, the extension/retraction units being respectively connected with the extension/retraction holes of the frame body and being each drivable by an external force to move reciprocally between an upward moved position and a downward moved position, wherein when set at the upward moved position, the extension/retraction units project outside of a top surface of the frame body, and when set at the downward moved position, the extension/retraction units do not project outside of the top surface of the frame body; and a mixing bowl, which comprises a bowl body, the bowl body defining a mixing space extending from top to bottom, the bowl body having an outside surface that is provided with a bowl peg extending in a horizontal direction to protrude outwards, the bowl peg being selectively insertable into and detachable from the frame channel of the support frame, the bowl body being provided, on two opposite sides of the outside surface thereof, with a support portion protruding outwards, each of the support portions being formed with a bowl channel extending in a vertical direction, wherein when the extension/retraction units are at the downward moved position, the support portions are placeable on the top surface of the frame body, and when the support portions are placed on the top surface of the frame body and the extension/retraction units are at the upward moved position, the extension/retraction units are inserted into the bowl channels. As such, effort saving, time saving, and increase of operation efficiency can be enhanced for mounting and removing the mixing bowl.

### BRIEF DESCRIPTION OF THE DRAWINGS

FIG. 1 is a schematic view showing a known mixer before assembling.

FIG. 2 is an exploded view showing a preferred embodiment of the present invention.

FIG. 3 is a perspective view showing the embodiment of FIG. 2 in an assembled state.

FIG. 4 is an exploded view showing components of the embodiment of FIG. 2.

FIGS. 5-9 are schematic views illustrating an operation of assembling of the embodiment of FIG. 2.

FIG. 10 is an exploded view showing another embodiment of the present invention.

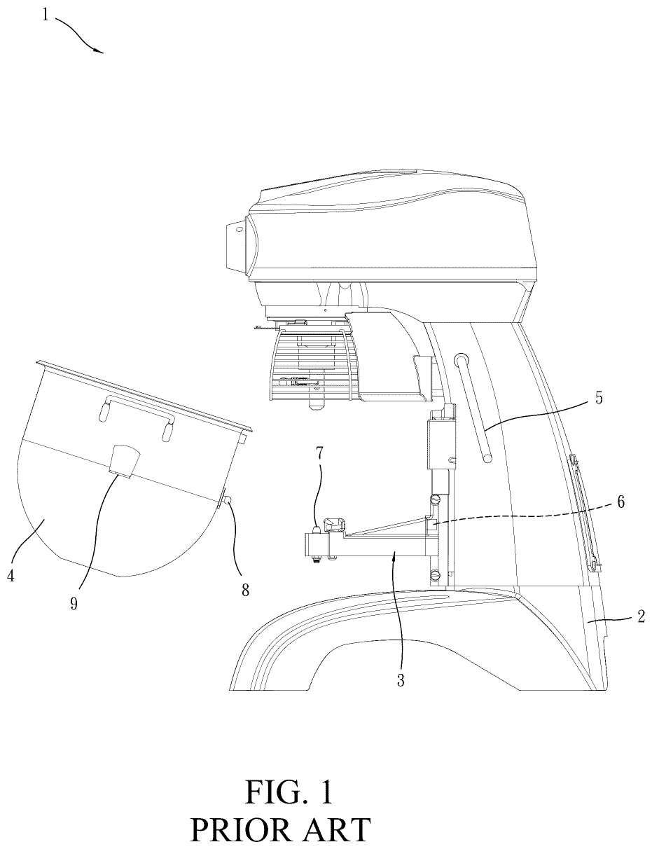

### DETAILED DESCRIPTION OF THE PREFERRED EMBODIMENTS

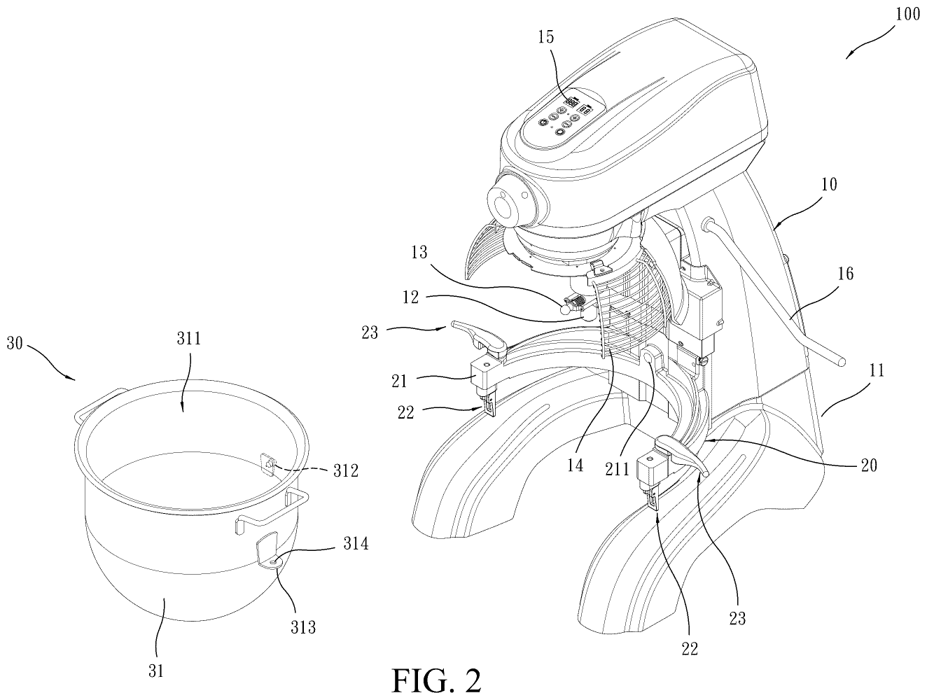

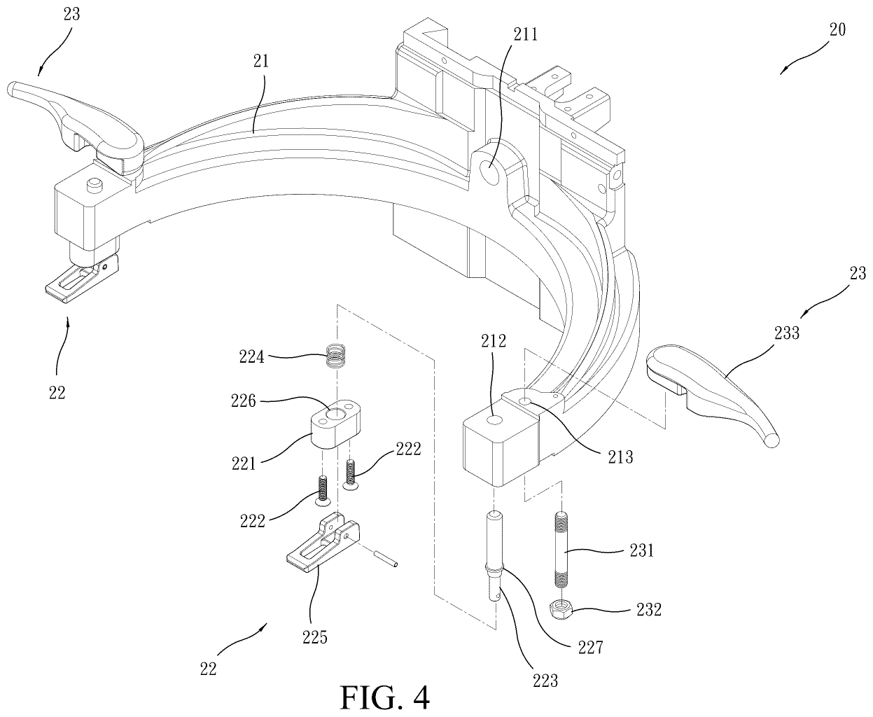

Referring to FIGS. 2-9, an easy-bowl-removal/mounting mixer 100 provided according to a preferred embodiment of the present invention is shown, mainly comprising a base 10, a support frame 20, and a mixing bowl 30.

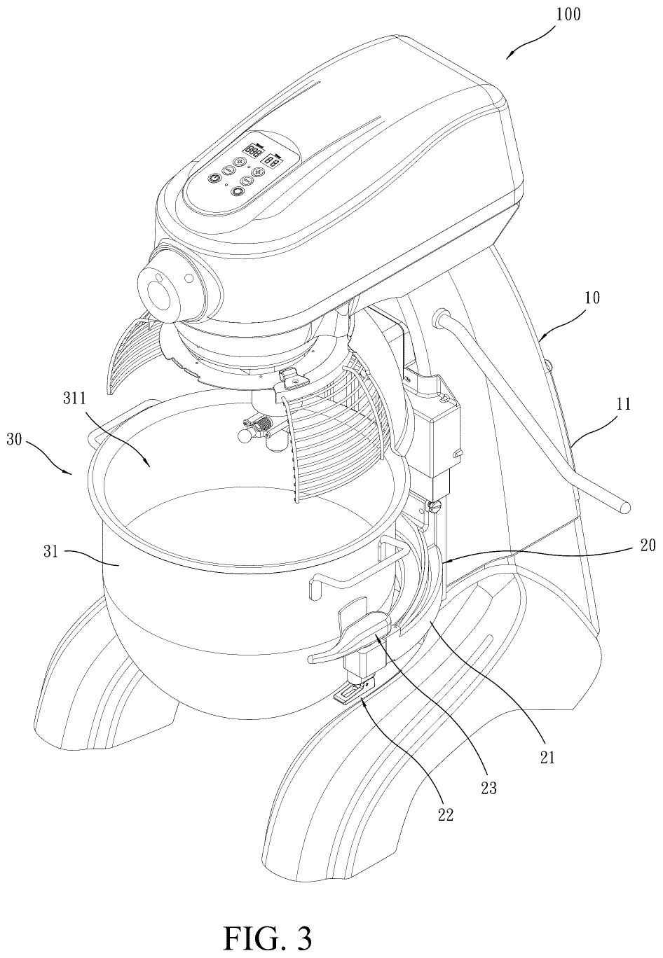

Referring to FIGS. 2 and 3, the base 10 includes a base body 11, a rotation power unit 12, a coupling unit 13, a protective grating 14, a control panel 15, and a crank handle 16. The base body 11 is stably placed on the ground or a flat surface. The rotation power unit 12 is arranged on the base body 11 to generate rotating power. The coupling unit 13 is connected to the rotation power unit 12 for receiving a stirring bar (not shown in the drawings) to attach thereto and detach therefrom, so that the rotating power is transmitted from the rotation power unit 12 to the stirring bar to drive the stirring bar to rotate. The protective grating 14 is arranged on the base body 11 and is rotatable by an external force applied thereto. The control panel 15 is arranged on the base body 11 to control the rotational speed, the rotation mode, and activation/deactivation of the rotation power unit 12. The crank handle 16 is arranged on the base body 11.

Referring to FIGS. 2-5, the support frame 20, includes a frame body 21, two extension/retraction units 22, and two detachment protection units 23. The frame body 21 is generally of an ox-horns configuration, meaning a generally semicircular ring configuration. A middle portion of the frame body 21 is connected, at an outer side thereof, to the base body 11 of the base 10 and is drivable by the crank handle 16 to move upwards and downwards. The middle portion of the frame body 21 includes, on an inner side surface thereof, a frame channel 211 extending in the horizontal direction. The frame body 21 is formed, in a position adjacent to each of two ends thereof, with an extension/retraction hole 212 penetrating through top and bottom thereof and a rotation aperture 213 adjacent to the extension/retraction hole 212 (namely one end of the frame body includes an extension/retraction hole and a rotation aperture and an opposite end also includes an extension/retraction hole and a rotation aperture). The extension/retraction units 22 are respectively connected with the extension/retraction holes 212 of the frame body 21. The two extension/retraction units 22 are identical to each other with respect to the structure and the way of assembling, and to avoid unnecessary repeating, only one of the extension/retraction units 22 will be described hereinafter. The extension/retraction unit 22 includes an extension/retraction base 221, two fastening elements 222, an extension/retraction bar 223, an elastic element 224, and a pull lever 225. The extension/retraction base 221 includes a base hole 226 penetrating through top and bottom thereof. The extension/retraction base 221 is arranged on a bottom surface of the frame body 11, and the base hole 226 corresponds to the extension/retraction hole 212. The fastening elements 222 are used to securely fix the extension/retraction base 221 to the bottom surface of the frame body 21. The fastening elements 222 are screws. The extension/retraction bar 223 is disposed in the base hole 226 and the extension/retraction hole 212. The extension/retraction bar 223 is provided, on an outer circumferential surface of a middle portion thereof, with a supporting ring 227. The elastic element 224 is a spring supported between an inside wall of the base hole 226 of the extension/retraction base 221 and the supporting ring 227 of the extension/retraction bar 223 to provide an elastic force for biasing the extension/retraction bar 223 to move upwards. The pull lever 225 is an eccentric lever pivotally connected to a bottom end of the extension/retraction bar 223, so that the pull lever 225, when acted upon by an external force to be set at a downward moved position, drives the extension/retraction bar 223 to compress the elastic element 224 and retract back downwards to thereby making a top end of the extension/retraction bar 223 not projecting outside of a top surface of the frame body 21, and the pull lever 225, when acted upon by an external force to be set at an upward moved position, causes the extension/retraction bar 223 not to compress the elastic element 224 and is instead acted upon by the elastic force of the elastic element to extend upwards, making the top end of the extension/retraction bar 223 projecting outside of the top surface of the frame body 21. The detachment protection units 23 are respectively connected to the rotation apertures 213 of the frame body 21. The two detachment protection units 23 are identical to each other with respect to the structure and the way of assembling, and to avoid unnecessary repeating, only one of the detachment protection units 22 will be described hereinafter. The detachment protection unit 23 includes a rotary axle 231, a screw nut 232, and a detachment-preventing handle 233. The rotary axle 231 is disposed in the rotation aperture 213 of the frame body 21. The screw nut 232 is screwed onto a bottom end of the rotary axle 231 and is set on the bottom surface of the frame body 21. The detachment-preventing handle 233 is connected, through screwing, to a top end of the rotary axle 231 and is set on the top surface of the frame body 21.

Referring to FIGS. 2-9, the mixing bowl 30 includes a bowl body 31 and two handles 32. The bowl body 31 defines a mixing space 311 extending from a top to a bottom thereof. The bowl body 31 is provided, on an outside surface thereof, with a bowl peg 312 that extends in a horizontal direction to protrude outwards. The outside surface of the bowl body 31 is provided, on each of two opposite sides, with a support portion 313 protruding outwards therefrom. Each of the support portions 313 is formed with a bowl channel 314 extending in the vertical direction. The two handles 32 are arranged on the outside surface of the bowl body 31 at two opposite sides to be gripped and held by an operator for moving the mixing bowl 30.

The above provides a description for each component of the easy-bowl-removal/mounting mixer 100 according to a preferred embodiment of the present invention and the way of assembling thereof. In the following, the features of operation will be described as follows:

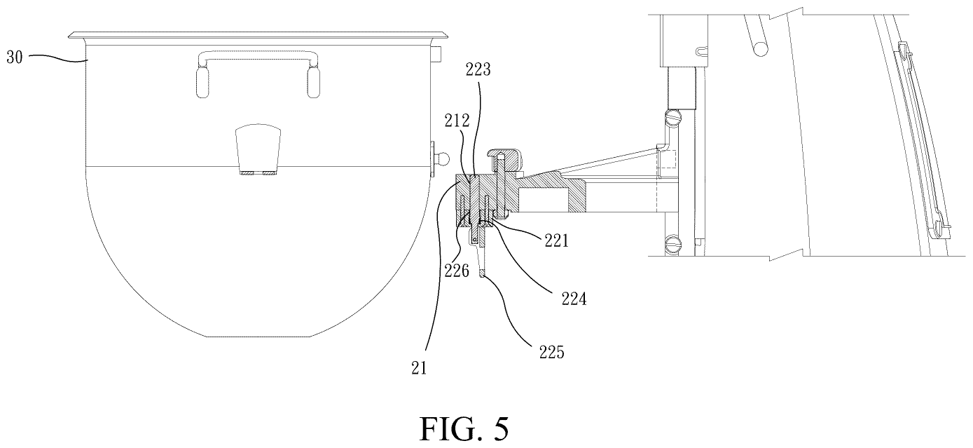

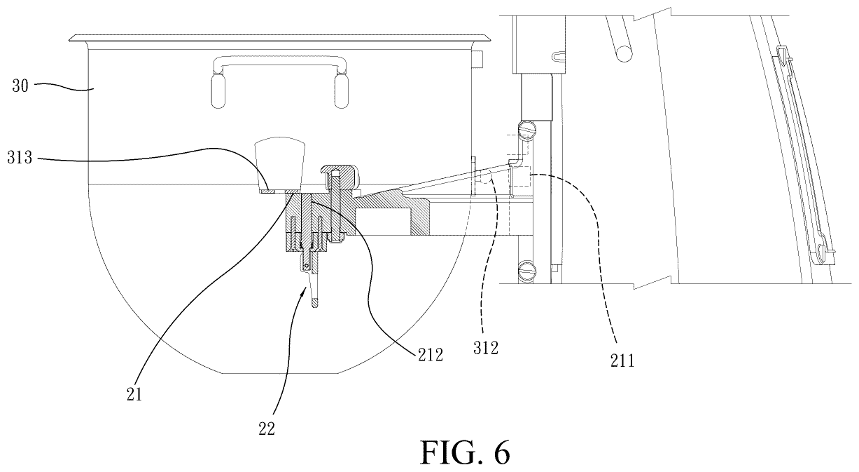

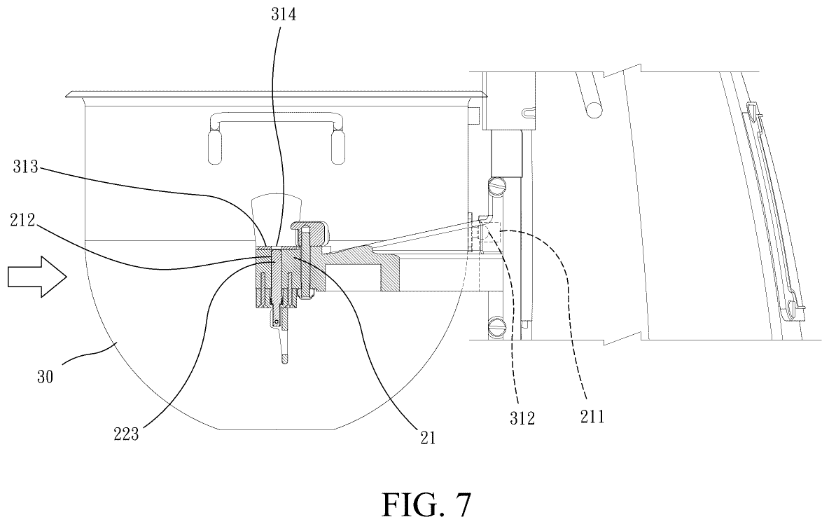

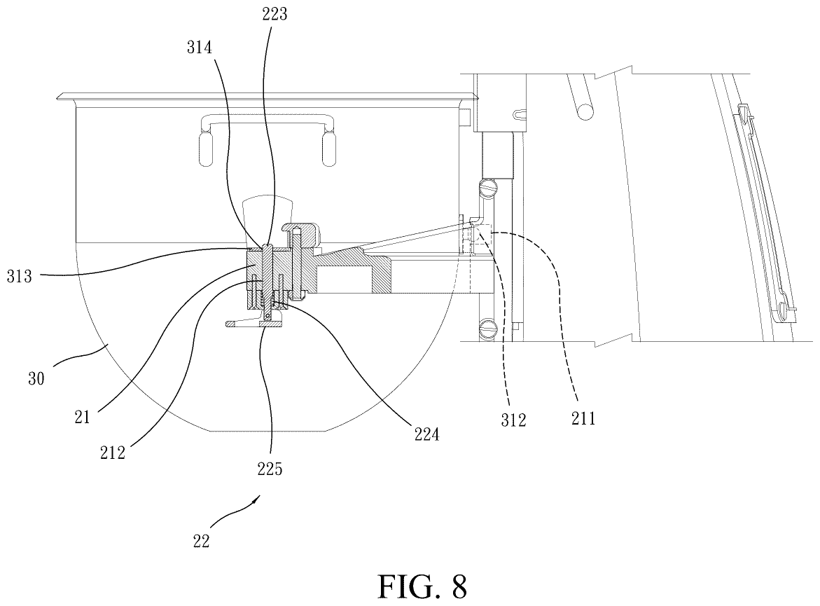

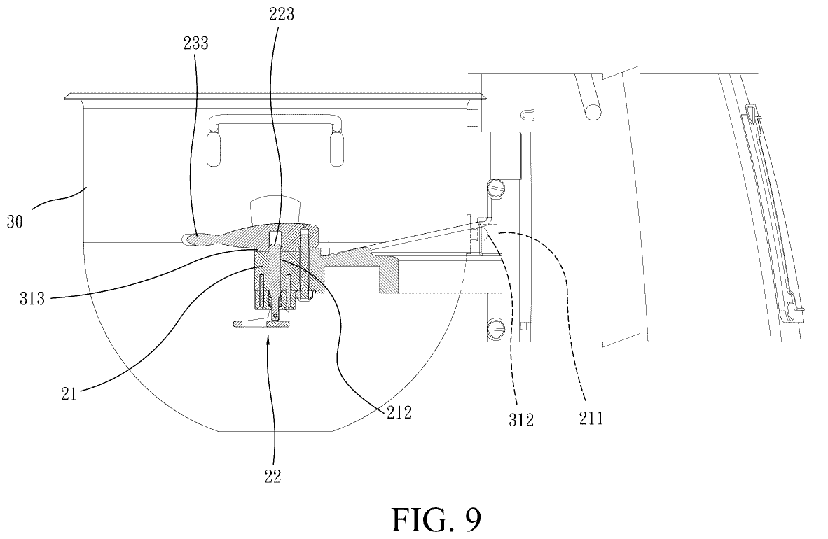

Firstly, to mount the mixing bowl 30 on the support frame 20, the pull lever 225 of each of the extension/retraction units 22 is first pulled to the downward moved position (where the pull lever 225 is perpendicular to the ground surface), so as to have the extension/retraction bar 223 retracting back into the extension/retraction hole 212 and not projecting outside of the top surface of the frame body 21 (as shown in FIG. 5). Then, the operator may move the mixing bowl 30 to have the support portions 313 of the mixing bowl 30 positioned on portions of the top surface of the frame body 21 where the extension/retraction holes 212 are formed (as shown in FIG. 6), so that the operator does not need to further move the mixing bowl 30, and physical strength can be saved by means of the support portions 313 positioned on the frame body 21 (and under this condition, the bowl peg 312 is set in exactly alignment with the frame channel 211). Then, the operator only needs to push and move the bowl peg 312 of the mixing bowl 30 toward the frame channel 211 of the support frame 20 to have the bowl peg 312 inserted into the frame channel 211 (as shown in FIG. 7). Then, the operator may pull the pull lever 225 of the extension/retraction units 22 to the upward moved position (where the pull lever 225 is parallel to the ground surface), so that, under this condition, the extension/retraction bar 223 is acted upon by the elastic element 224 to extend upwards to partially project outside of the extension/retraction hole 212 and insert into the bowl channel 314 of the mixing bowl 30 (as shown in FIG. 8), so that under this condition, three-point positioning (the bowl peg inserting into the frame channel, and the two extension/retraction bars inserting into the two bowl channels) is achieved between the mixing bowl 30 and the support frame 20. Finally, the operator rotates the detachment-preventing handles 233 of the detachment protection units 23 to locations respectively above top ends of the extension/retraction bars 223 and the support portions 313 (as shown in FIG. 9) to exhibit a holding-down state in order to ensure that the support portions 313 of the mixing bowl 30 do not detach from the extension/retraction units 22 to thereby enhance safety. To remove the mixing bowl 30 from the support frame 20, an operation is performed in an opposite sequence.

As such, the present invention reduces the process of mounting the mixing bowl and removing the mixing bowl, making the operations of mounting and removing more efficient and making the operator not necessarily taking a strange posture for carrying out mounting and removing, so as to achieve advantages of easy operation, reduction of operation time, and increase of operation efficiency. Further, before inserting the bowl peg of the mixing bowl into the frame channel of the support frame and inserting the extension/retraction bars into the extension/retraction holes, the operator already places the mixing bowl on the support frame, so that by means of the support portions being placed on and supported by the top surface of the frame body in a condition where the extension/retraction bars are retracted backwards, whereby the entire process is that aligning is achieved when being placed, and is different from the prior art where moving is has to perform before aligning, and as such, the present invention can fulfill an effect of great effort saving.

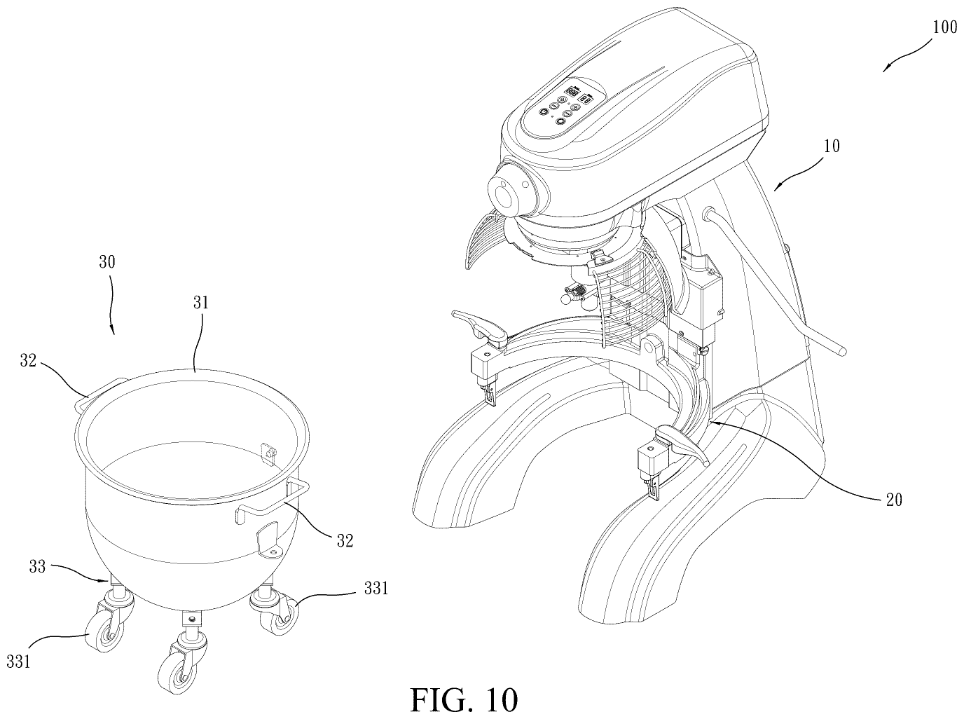

Further, referring to FIG. 10, the mixing bowl 30 according to the present invention may further include a stand 33. The stand 33 includes a plurality of casters 331. The bowl body 31 can be set on the stand 33 and moving the stand 33 causes the mixing bowl 30 to move together, and there is no need to further apply a force to separately move the mixing bowl 30, making it more effort saving and easier to mount and remove the mixing bowl 30.

I claim:

1. An easy-bowl-removal/mounting mixer, comprising:
a base;
a support frame, which comprises a frame body and two extension/retraction units, a middle portion of the frame body being connected, at an outer side thereof, to the base, the middle portion of the frame body being formed, in an inner side surface thereof, with a frame channel that extends in a horizontal direction, the frame body being formed, in a position adjacent to each of two ends thereof, with an extension/retraction hole, the extension/retraction units being respectively connected with the extension/retraction holes of the frame body and being each drivable by an external force to move reciprocally between an upward moved position and a downward moved position, wherein when set at the upward moved position, the extension/retraction units project outside of a top surface of the frame body, and when set at the downward moved position, the extension/retraction units do not project outside of the top surface of the frame body; and
a mixing bowl, which comprises a bowl body, the bowl body defining a mixing space extending from top to bottom, the bowl body having an outside surface that is provided with a bowl peg extending in a horizontal direction to protrude outwards, the bowl peg being selectively insertable into and detachable from the frame channel of the support frame, the bowl body being provided, on two opposite sides of the outside surface thereof, with a support portion protruding outwards, each of the support portions being formed with a bowl channel extending in a vertical direction, wherein when the extension/retraction units are at the downward moved position, the support portions are placeable on the top surface of the frame body, and when the support portions are placed on the top surface of the frame body and the extension/retraction units are at the upward moved position, the extension/retraction units are inserted into the bowl channels.

2. The easy-bowl-removal/mounting mixer according to claim 1, wherein the base comprises a base body, a rotation power unit, a coupling unit, a protective grating, a control panel, and a crank handle, the frame body of the support frame being connected to the base body, the rotation power unit being arranged on the base body to generate rotating power, the coupling unit being connected to the rotation power unit and adapted to receive a stirring bar to mount thereto and dismount therefrom, the protective grating being arranged on the base body and adapted to be acted upon by an external force to rotate, the control panel being arranged on the base body to control rotational speed, rotation mode, and activation/deactivation of the rotation power unit, the crank handle being arranged on the base body for driving the support frame to elevate and lower.

3. The easy-bowl-removal/mounting mixer according to claim 1, wherein the frame body is of an ox-horns configuration.

4. The easy-bowl-removal/mounting mixer according to claim 1, wherein the extension/retraction units each comprises an extension/retraction base, an extension/retraction bar, an elastic element, and a pull lever, the extension/retraction base being formed with a base hole penetrating top and bottom, the extension/retraction base being arranged on a bottom surface of the frame body, the base hole being aligned with the extension/retraction hole, the extension/retraction bar being disposed in the base hole and the extension/retraction hole, the extension/retraction bar having an outer circumferential surface on which a supporting ring is formed, the elastic element being supported between an inside wall of the base hole of the extension/retraction base and the supporting ring of the extension/retraction bar to provide an elastic force for biasing the extension/retraction bar to move upwards, the pull lever being an eccentric bar pivotally connected to a bottom end of the extension/retraction bar, so that the pull lever, when acted upon by an external force to be set at the downward moved position, drives the extension/retraction bar to compress the elastic element and retract back downwards, making a top end of the extension/retraction bar not projecting outside of the top surface of the frame body, and the pull lever, when acted upon by an external force to be set at the upward moved position, drives the extension/retraction bar not to compress the elastic element and is acted by the elastic force of the elastic element to extend upwards, making the top end of the extension/retraction bar projecting outside of the top surface of the frame body.

5. The easy-bowl-removal/mounting mixer according to claim 4, wherein the extension/retraction unit further comprises at least one fastening element, the fastening element being applied to fix the extension/retraction base to the bottom surface of the frame body.

6. The easy-bowl-removal/mounting mixer according to claim 4, wherein the elastic element comprises a spring.

7. The easy-bowl-removal/mounting mixer according to claim 1, wherein the support frame further comprises two detachment protection units; a rotation aperture is formed in the frame body at a location adjacent to each of two ends thereof to penetrate top and bottom; the detachment protection units are respectively connected to the rotation apertures of the frame body, the detachment protection units comprising a rotary axle, a screw nut, and a detachment-preventing handle, the rotary axle being disposed in the rotation aperture, the screw nut being screwed to a bottom end of the rotary axle and positioned on the bottom surface of the frame body, the detachment-preventing handle being in screwed engagement with a top end of the rotary axle and positioned on the top surface of the frame body; the detachment-preventing handle is acted upon by an external force to rotate to hold down or not hold down on the support portions and the extension/retraction units.

8. The easy-bowl-removal/mounting mixer according to claim 1, wherein the mixing bowl further comprises two handles, the two handles being arranged on the bowl body on two opposite sides of the outside surface.

9. The easy-bowl-removal/mounting mixer according to claim 1, wherein the mixing bowl further comprises a stand, the stand comprising a plurality of casters, the stand receiving the bowl body to position thereon.
